(19) United States
(12) Patent Application Publication
(10) Pub. No.: US 2019/0011698 A1
(43) Pub. Date: Jan. 10, 2019

(54) METHOD AND SYSTEM FOR FACILITATING PROVISIONING OF HOLOGRAPHIC CONTENT

(71) Applicant: Pierce Elliott James, Lynnfield, MA (US)

(72) Inventor: Pierce Elliott James, Lynnfield, MA (US)

(21) Appl. No.: 15/964,488

(22) Filed: Apr. 27, 2018

Related U.S. Application Data
(60) Provisional application No. 62/530,715, filed on Jul. 10, 2017.

(51) Int. Cl. G02B 27/01; G03H 1/04

(52) U.S. Cl. CPC G02B 27/0101; G03H 2001/2255; G03H 1/0408

(57) ABSTRACT

Disclosed is a wearable display device configured to facilitate provisioning of holographic content in cooperation with at least one computing device. The wearable display device may include at least one sensor configured to detect sensor data corresponding to one or more of a location and an orientation of the wearable display device. Further, the wearable display device may include a communication interface configured to transmit the sensor data to the at least one computing device. Further, the communication interface may be configured to receive holographic projection content from the at least one computing device. Further, the wearable display device may include a processor communicatively coupled to the communication interface. Further, the processor may be configured to process the holographic projection content. Further, the wearable display device may include a display device configured to generate a visual display of the holographic projection content.

### FIELD OF THE INVENTION

The present invention relates generally to augmented reality, in particular, the present invention relates to a method and a system of facilitating provisioning of holographic content on a wearable display device.

### BACKGROUND OF THE INVENTION

Augmented reality (AR) technologies are gaining popularity with users across the world. These technologies aim to provide new user experiences to users to augment their life and entertainment.

However, AR devices are often quite complex and costly. The conventional AR devices often employ specialized wearable glasses. These devices performing multiple functions including tracking the location and orientation of the user, performing all the processing, and then displaying the images to the user based on the location and orientation of the user.

Accordingly, there is a need for improved systems and methods of facilitating provisioning of holographic content on a wearable display device that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a wearable display device configured to facilitate provisioning of holographic content in cooperation with at least one computing device. The wearable display device may include at least one sensor configured to detect sensor data corresponding to one or more of a location and an orientation of the wearable display device. Further, the wearable display device may include a communication interface configured to transmit the sensor data to the at least one computing device. Further, the communication interface may be configured to receive holographic projection content from the at least one computing device. The communication interface may include one or more of a wired communication interface and a wireless communication interface. For example, the communication interface may be based on a near-field communication protocol such as, but not limited to, Bluetooth, ZigBee, Infrared (IR) communication, RFID and so on. Alternatively, and/or additionally, the wireless communication interface may be based on a wireless network such as, but not limited to, WiFi, WiMax, Wibro, WiGig, WLAN etc. Further, the holographic projection content may be generated by the at least one computing device based on the sensor data. Further, the wearable display device may include a processor communicatively coupled to the communication interface. Further, the processor may be configured to process the holographic projection content. Further, the wearable display device may include a display device communicatively coupled to the processor. Further, the display device may be configured to generate a visual display of the holographic projection content.

According to some embodiments, a computing device configured to facilitate provisioning of holographic content in cooperation with one or more wearable display devices is disclosed. The computing device may include at least one sensor configured to detect sensor data corresponding to one or more of a location and an orientation of the one or more wearable display devices. Further, the computing device may include a processor communicatively coupled to the at least one sensor. Further, the processor may be configured to generate at least one holographic projection content based on the sensor data. Further, the computing device may include a communication interface configured to transmit the at least one holographic projection content to the one or more wearable display devices. The communication interface may include one or more of a wired communication interface and a wireless communication interface. For example, the communication interface may be based on a near-field communication protocol such as, but not limited to, Bluetooth, ZigBee, Infrared (IR) communication, RFID and so on. Alternatively, and/or additionally, the wireless communication interface may be based on a wireless network such as, but not limited to, WiFi, WiMax, Wibro, WiGig, WLAN etc. Further, the one or more wearable display devices may be configured to generate at least one visual display of the holographic projection content.

According to some embodiments, a method for providing holographic content based on cooperation of at least one computing device and at least one extraneous display device is disclosed. The method may include establishing, using a communication interface, a communication session between the at least one computing device and the at least one extraneous display device. Further, the method may include determining, using at least one sensor, sensor data corresponding to one or more of a location and an orientation associated with the at least one extraneous display device. Further, the method may include generating, using a processor, holographic projection content based on the sensor data. Further, the method may include transmitting, using the communication interface, the holographic projection content from the at least one computing device to the at least one extraneous display device. Further, the at least one extraneous display device may be configured for displaying the holographic projection content.

According to some embodiments, the present disclosure provides an augmented reality protocol that utilizes modular holotags, offers multi-user experiences originating from a central, primary computing device, engages a programmable phase that enables the user to upload, deposit, and share augmented reality content, and universalizes augmented reality content in the form of holotags such as AR codes and Internet-connected content.

Further, the disclosed method utilizes an extraneous display device such as screen equipped glasses, and a computing device with one or more sensors such as a smartphone with a camera to provide augmented reality experience to the users.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flowchart of a method to provide an interactive augmented reality experience in accordance with some embodiments.

FIG. 2 is a flowchart of a method for initiating the registration phase for providing the interactive augmented reality experience in accordance with some embodiments.

FIG. 3 is a flowchart of a method for initiating the operation phase for providing the interactive augmented reality experience in accordance with some embodiments.

FIG. 4 is a flowchart of a method for initiating the programmable phase for providing the interactive augmented reality experience in accordance with some embodiments.

FIG. 5 is a flowchart of a method for initiating the shared operation phase for providing the interactive augmented reality experience in accordance with some embodiments.

FIG. 6 is a flowchart of a method for initiating the market phase for providing the interactive augmented reality experience in accordance with some embodiments.

FIG. 7 illustrates a system for providing the interactive augmented reality experience in accordance with some embodiments.

FIG. 8 is an illustration of a platform consistent with various embodiments of the present disclosure.

FIG. 9 is a block diagram of a wearable display device configured to facilitate provisioning of holographic content in cooperation with one or more computing devices in accordance with some embodiments.

FIG. 10 illustrates a visual display of the holographic projection content in accordance with an exemplary embodiment.

FIG. 11 is a block diagram of a computing device configured to facilitate provisioning of holographic content in cooperation with one or more wearable display devices in accordance with some embodiments.

FIG. 12 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of augmented reality, embodiments of the present disclosure are not limited to use only in this context.

### Overview

The present disclosure relates to an application and method thereof that enables an interactive augmented reality experience that utilizes a conventional computing device and an extraneous display device such as a screen equipped pair of glasses, wherein the user's proximity and orientation to the computing device reflects the display of a holotag projection.

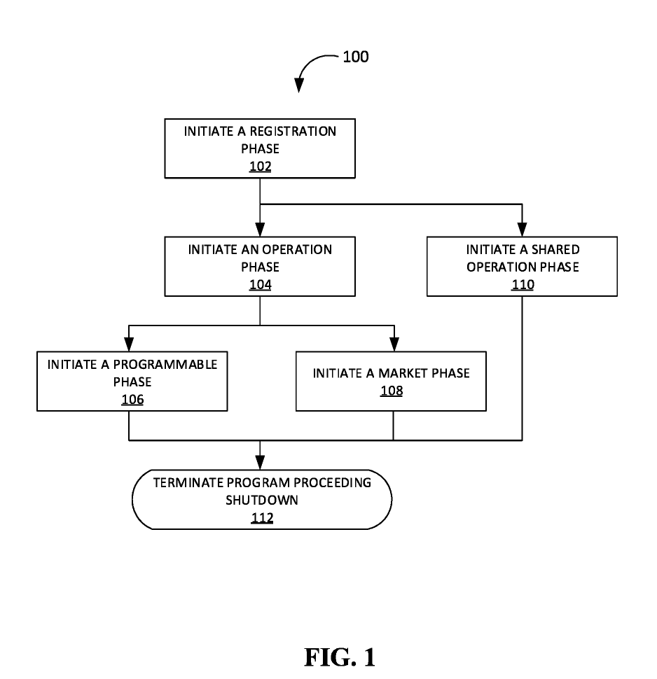

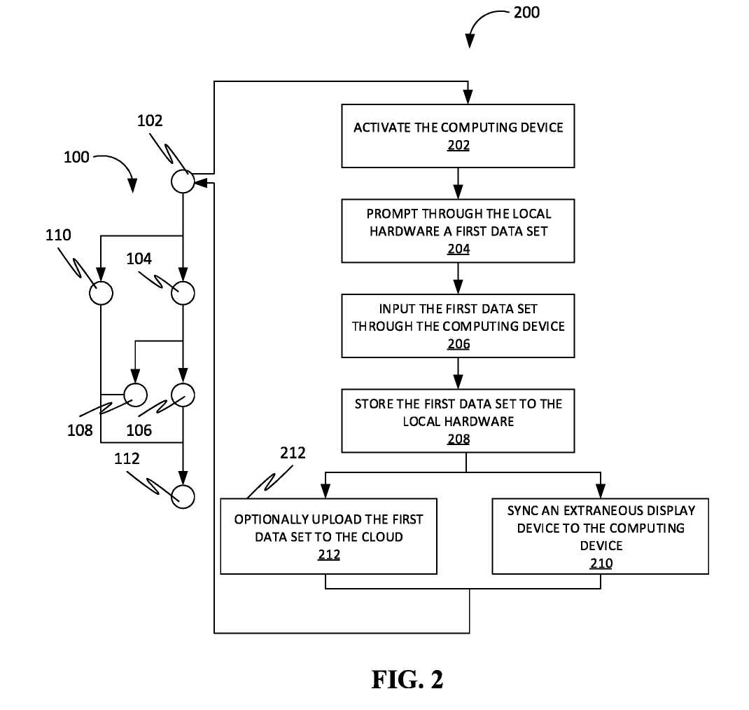

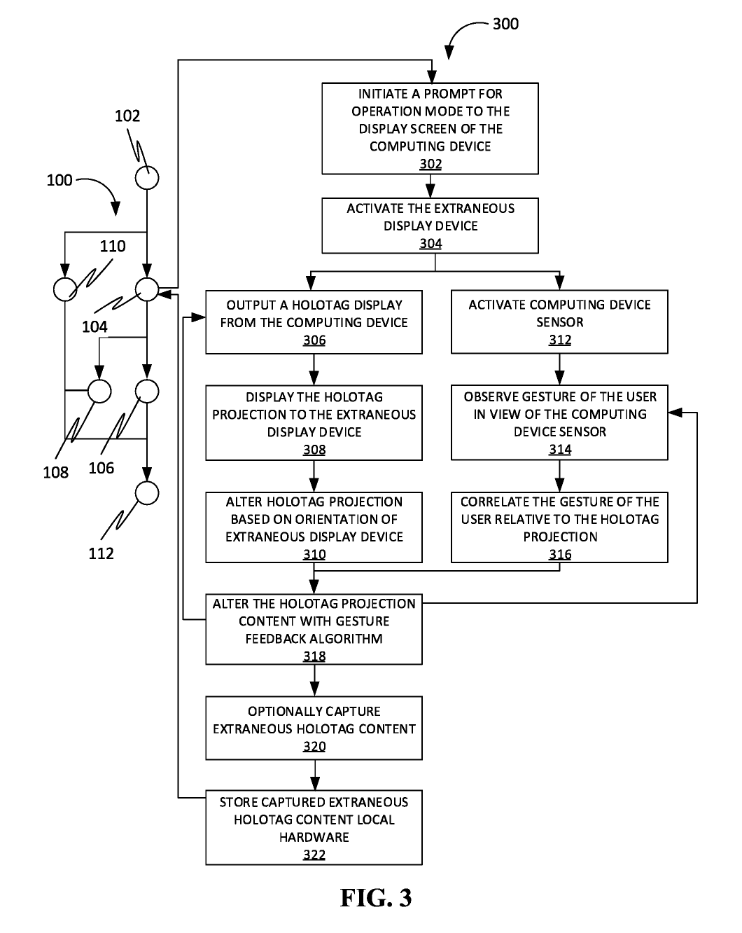

FIG. 1 is a flowchart of a method 100 to provide an interactive augmented reality experience in accordance with some embodiments. The method 100 includes initiating the registration phase at 102, initiating an operation phase at 104, and initiating a programmable phase at 106. The registration phase is explained in further detail in conjunction with FIG. 2 below. The operation phase is explained in further detail in conjunction with FIG. 3 below. Further, when the operation phase concludes, a user may be given an opportunity to enter the programmable phase (at 106) or a market phase at 108. Further, after the conclusion of the registration phase, the user may elect to enter an operation phase where they alone are party to the application, or initiating a shared operation phase (at 110) where the user may broadcast holotag projection content to one or more additional users and/or use one or more computing devices and sensors. At 112, the program may be terminated when the user initiates the shutdown.

FIG. 2 is a flowchart of a method 200 for initiating the registration phase for providing the interactive augmented reality experience in accordance with some embodiments. The method 200 may include activating a computing device at 202, prompting through the local hardware a first data set at 204, inputting the first data set through the computing device at 206, storing the first data set to the local hardware at 208, and subsequently the latter may be proceeded by a simultaneous pair of steps that includes syncing an extraneous display device to the computing device at 210, and optionally uploading the first data set to the cloud at 212. The registration phase relates to establishing the user identity uniquely to the computing device, syncing their extraneous display device, and optionally registering the user to a cloud or internet equipped network through a first data set. The computing device may constitute a smartphone, a PDA, a laptop, etc.

Accordingly, at 202, the computing device is first activated and rendered into an operational state that allows the input and display of information. Thereafter, at 204, the user may be offered a prompt (or a plurality thereof) through the computing device display where a first data set may be presented in a plurality of fields such as, but not limited to, a name, an age, a platform, interests, and so on. Subsequently, at 206, the user may input the relevant information to the computing device through input means including, but not limited to, embedded keyboards, touch screens, voice input, etc. The first plurality of data may relate to the identity and information of the user to discretize holotag content captured by, manipulated, and saved by the user.

Then, at 208, the first data set is then uploaded to the local hardware of the computing device such as an onboard database or memory bank to officially register the user locally to the computing device. After uploading the first data set to the local hardware, the application may synchronize an extraneous display device, such as screen equipped glasses, to the computing device (at 210) simultaneously with optionally uploading the first data set to the cloud (at 212). Optionally, the first data set may be uploaded to the cloud if an internet connection is present and may occur simultaneously alongside the syncing of an extraneous display device when the computing device's wireless capabilities are engaged.

Accordingly, the method 200 may follow a linear registration algorithm to establish the user to the application on the computing device and proceeding to synchronize the extraneous display device to the computing device. Simultaneously, the user may opt to upload the first data set to a dedicated cloud network for financial transactions or social media participation.

FIG. 3 is a flowchart of a method 300 for initiating the operation phase for providing the interactive augmented reality experience in accordance with some embodiments. At 302, the method 300 may include initiating a prompt for operation mode to the display screen of the computing device. Further, at 304, the method 300 may include activating the extraneous display device. Whereupon the method 300 (or protocol) diverges into two separate but simultaneous processes of three steps each where the first path comprises in sequence: outputting a holotag display from the computing device at 306, displaying the holotag projection to the extraneous display device at 308, and altering the holotag projection based on orientation of the extraneous display device at 310. The second simultaneous path comprises in sequence: activating the computing device sensor at 312, observing gestures of the user in view of the computing device sensor at 314, and correlating the gesture of the user relative to the holotag projection at 316. The two paths may converge together again into a series of three steps in sequence: altering the holotag projection content with gesture feedback algorithm at 318, optionally capturing extraneous holotag content at 320, and storing captured extraneous holotag content to the local hardware at 322. Further, the operation may protocol between altering the holotag projection content with gesture feedback algorithm, to both outputting a holotag display from the computing device, and observing gestures of the user in view of the computing device sensor for the duration of the operation phase.

Following initiating the registration phase, the application may engage either an operation phase, or a shared operation phase. Preferably, the application may default to the operation phase concerning a protocol, wherein the user is a sole party to the application and broadcast of information to extraneous display devices.

Further, after the registration phase, the application may immediately initiate a prompt for operation mode to the display screen of the computing device. However, if the application is terminated and restarted, the application may preferably offer the operation phase as the preferred action of the onset of the program. The user may either manually engage their extraneous display device or the application may utilize the synchronization established during registration to override the manual activation of the extraneous display device. The extraneous display device may preferably be a pair of screen equipped glasses or a headset that possesses a proximity sensor attached arbitrarily but capable of quantifying the distance and orientation of the extraneous display device to the computing device and holotag projection content.

Upon activation of the extraneous display device and the initiation of the operation phase, the computing device may then output a holotag display from the computing device through the screen that may be readable to other computing devices and serve as an anchor for the holotag projection content. The holotag projection may then be displayed to the extraneous display device, wherein the device may produce an orientation, wherein the eyesight of the user is not obstructed relative to the holotag display. Through the proximity sensor located on the extraneous display device, the computing device may alter the holotag projection to reflect the orientation and proximity of the user's headset. This method may then repeat indefinitely for the length of the operation phase to permit a continuous interaction and engagement with the holotag projection content.

Further, simultaneously to the outputting of the holotag display from the computing device, the computing device sensor (or plurality thereof) may be activated. The compute device sensor may preferably utilize sensors including but not limited to visual sensors such as cameras, comprehensive light intensity sensors, sound-based sensors, and so on. The computing device sensor may be understood to be disparate of the dedicated sensor located on the computing device to detect and communicate with the proximity sensor located on the extraneous display device. The computing device sensor (or plurality thereof) may then observe the user's gestures in view of the computing device sensor that may coincide with the point in space that the holotag projection content is presently anchored and presented within. The computing device may utilize an algorithm that correlates the gesture of the user relative to the projected holotag and the content therein, such as if the user's finger visually is observed in the space over the computing device sensor and in proximity to the digitized holotag projection content, such as a ball.

Further, by tracking the location of the user's finger in space with respect to the holotag projection content, the algorithm may alter the holotag projection content through a gesture feedback algorithm, such as pushing or deforming the ball dependent on the computing capabilities of the computing device. This process may occur indefinitely and simultaneously alongside the streaming of information to the extraneous display device to present a continuous interaction experience wherein the user is engaged with the digital content. This method may be used for an operation as simple as playing with a ball, or engaging an optimized copy of the computing device that may be rescaled or manipulated, but still operate in the same manner as the computing device itself. This offers enhanced functionalities above the tangible computing device and also offers a privacy that only the user is party to. While in the operation mode and on the go, the user may optionally capture extraneous holotag content such as those embedded in stationary media, such as posters, or dynamic media, such as digitally streamed media or even other user's holotag displays given adequate permissions. Upon capturing this extraneous holotag content, the application may store the captured extraneous holotag content to the local hardware of the computing device for later review, programming, manipulation, or sharing.

Accordingly, the method 300 may proceed with the assumption the computing device is currently on, wherein a prompt may be engaged by the user, initiating the operation mode and with successful syncing, may activate the extraneous display device or establish a dedicated link to the computing device. Thereafter, the two simultaneous process flows may produce the gesture feedback algorithm that may continue throughout the operation phase, wherein the user may capture extraneous holotag content if the application is used in a public setting where a holotag is present.

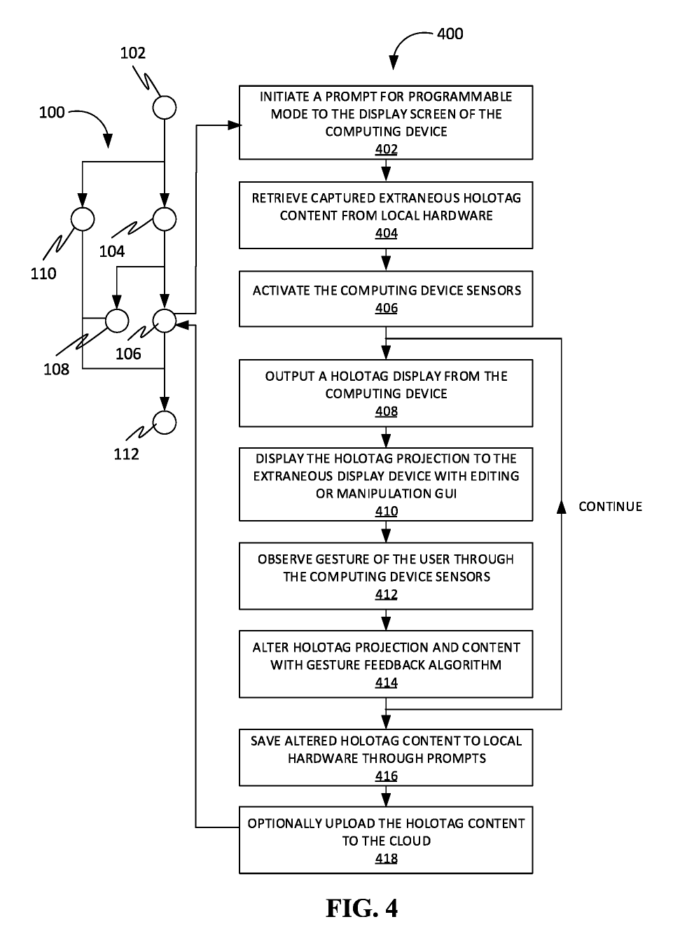

FIG. 4 is a flowchart of a method 400 for initiating the programmable phase for providing the interactive augmented reality experience in accordance with some embodiments. The method 400 may include initiating a prompt for the programmable mode to the display screen of the computing device at 402, retrieving captured extraneous holotag content from the local hardware at 404, activating the computing device sensors at 406, outputting a holotag display from the computing device at 408, displaying the holotag projection to the extraneous display device with an editing or manipulation graphical user interface (GUI) at 410, observing gestures of the user through the computing device sensors at 412, altering holotag projection and content with gesture feedback algorithm at 414, saving altered holotag content to local hardware through prompts at 406, and optionally uploading the holotag content to the cloud at 418. The programmable method may continuously loop between altering the holotag projection content with the gesture feedback algorithm (at 414) and output a holotag display from the computing device (at 408).

The initiation of the programmable phase may optimally proceed the operation phase once compatible holotag projection content has been captured or purchased through the market phase. The programmable phase may offer the user a means to customize or generate holotag projection content through a native editing or manipulation graphical user interface (GUI) that may be operated through the physical computing device's input means or optimally through the gestures of the user to test, craft, or alter the holotag projection content. After which, the user may upload the holotag projection content to the cloud, market, shared among friends, or anchored to an extraneous holotag for others to observe, manipulate, capture, or purchase.

Further, to initiate the programmable phase, a prompt may be initiated related to the programmable mode to the display screen of the computing device. Accordingly, the user may elect to accept or decline the programmable mode. Through either the computing device's native physical controls or preferably the gesture algorithm if following immediately after the operation mode, the user may retrieve a captured extraneous holotag content from the local hardware. Further, the user may additionally initiate a new holotag projection content from scratch with provided templates or programming foundations. The computing device's sensors may be then activated and may remain activated for the duration of the programmable phase if they were not already activated proceeding the operation phase.

Further, the holotag display may be then subsequently outputted from the computing device to permit either local users who are authorized to do so to observe the holotag projection content. The holotag projection may be then displayed to the extraneous display device with an editing or manipulation GUI that may permit the user to model, alter, and interact with the captured holotag projection content stored in the local hardware. Further, throughout the operation of the programmable phase, the gestures of the user may be observed through the computing device sensors in relation and proximity to the holotag projection content in the space above the computing device. The holotag projection content may be continually altered through the gesture feedback algorithm, wherein the extraneous display device is continually updated to reflect the interactions of the user.

Further, when deemed satisfactory to the user, the altered holotag content may then be saved to the local hardware of the computing device through a series of prompts that may include a plurality of fields concerning the name, designation, permissions, and so on. Optionally, upon saving the altered holotag content to the local hardware, the holotag content may be uploaded to the cloud to be shared with others, anchored to an extraneous holotag, or offered for purchase on the cloud market.

Accordingly, the method 400 may include the user bringing up captured extraneous holotag content stored in the local hardware and subsequently manipulated with in the editing or manipulation graphical user interface (GUI). During the course of editing and manipulation, the application may react to the user's gestures and actions and reflect such changes immediately to the extraneous display device. Further, the altered content may be saved to the local hardware of the computing device or shared with others either by implanting into the holotag or uploading to the cloud.

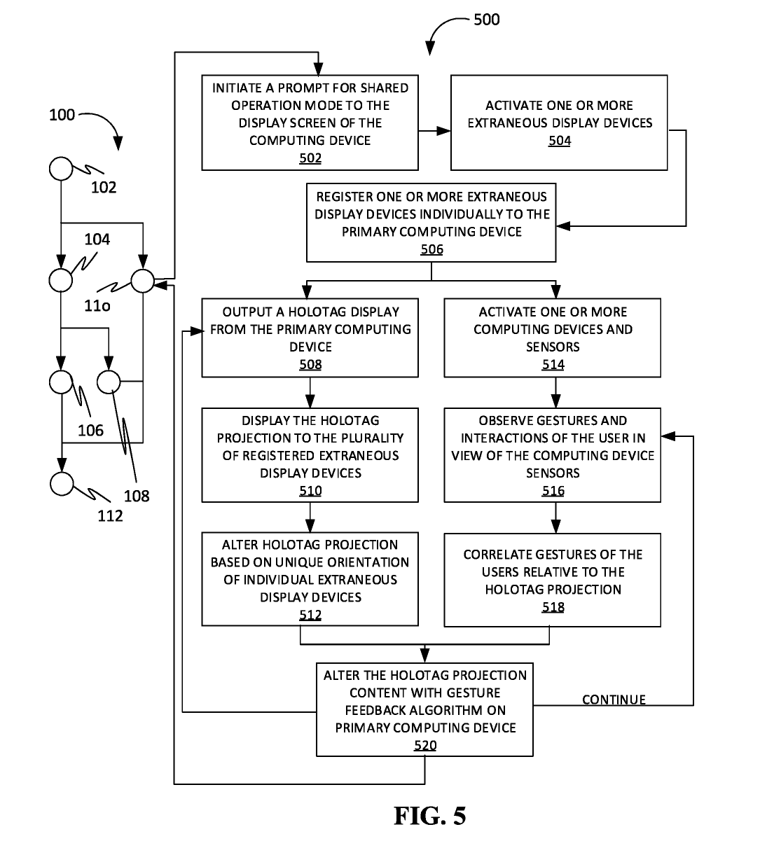

FIG. 5 is a flowchart of a method 500 for initiating the shared operation phase for providing the interactive augmented reality experience in accordance with some embodiments. The method 500 may include a series of three steps in sequence: initiating a prompt for shared operation mode to the display screen of the computing device at 502, activating one or more extraneous display devices at 504, and registering one or more extraneous display devices individually to the primary computing device at 506. The method 500 may diverge into two separate but simultaneous paths that comprise three steps each. The first path may include outputting a holotag display from the primary computing device at 508, displaying the holotag projection to the plurality of registered extraneous display devices at 510, and altering the holotag projection based on unique orientation of individual extraneous display devices at 512. The second path may include in sequence: activating one or more computing devices and sensors at 514, observing gestures and interactions of the user in view of the computing device sensors at 516, and correlating the gesture of the users relative to the holotag projection at 518. Thereafter the two paths may converge to a single step that comprises: altering the holotag projection content with gesture feedback algorithm on the primary computing device at 520. Further, the shared operation mode may loop continuously therefrom to both outputting a holotag display from the primary computing device (at 508), and observing gestures and interactions of the users in view of the computing device sensors (at 514).

Further, if the user at the conclusion of the registration phase chooses to allow multiple users to engage with the holotag projection content or view, a shared operation phase may be initiated that may allow multiple registered users to be party to the standard operation phase of application, or offer enhanced sensor capability by utilizing a larger plurality of sensors than a standalone computing device may offer.

Further, to initiate the shared operation phase, a prompt for shared operation mode may be forwarded to the display screen of the computing device on demand, where the user may authorize or deny the shared operation mode. Upon recognition and initiating the shared operation mode, one or more extraneous display devices may be activated. These alternative extraneous display devices may alter from the user's extraneous display device but may require a compatible proximity sensor that can engage with the user's computing device as the primary computing device. The one or more extraneous display devices may be then registered individually to the primary computing device either through a shared application registration and authorization granted between the other user's computing devices. Alternatively, the authorization of viewing may be granted through the primary computing device of the initial user that initiated the shared operation mode and subsequently synchronize the one or more extraneous display devices similar to the registration phase. Additionally, one or more computing devices may be registered at this stage either through a shared authorization acknowledgement or pre-registered relationships that may expand the number of sensors that the application can make use of in the local area. Such a method may effectively line a room in sensors or solely utilize the primary computing device's sensors to offer a wide range of sensory and potentially processing power that can be spread out across the computing device network.

Subsequently, the application may follow a method similar to the operation phase, wherein the holotag display may be outputted from the primary computing device's display screen. Thereafter the holotag projection content may be displayed to the plurality of registered extraneous display devices similarly to the user's own extraneous display device. In altering the holotag projection based on the unique orientation of the individual extraneous display devices, the computing device may communicate with the proximity sensors of the one or more extraneous display devices through a discretizing algorithm that may separately handle each extraneous display device relative to the unique orientation and proximity relative to the primary computing device. The alteration may immediately impact the angle of view, the magnification in proximity to the holotag projection content, and any engagements made by the user through gestures produced over the computing device sensors or the plurality thereof.

Simultaneously with the output of the holotag display from the primary computing device, the activation of one or more computing devices and sensors occurs that may solely involve the user's primary computing device, or engage one or more computing devices that may expand the field of sensors available to the primary computing device. Thereafter, gestures and interactions of the user (or the plurality thereof) in view of the computing device sensors may be observed. Primarily, the primary computing device may serve as the basic collection of sensors but may, in the shared operation mode, permit a plurality of one or more computing devices to be registered and linked to the primary computing device and subsequently an equal or greater plurality of sensors. Therefore, the level of engagement the primary computing device and the holotag projection content may be as simple as a single manipulatable object, or as comprehensive as a room lined sensor field that can handle multiple manipulatable objects in a single instance. Similar to the operation phase, the application phase may utilize an algorithm that correlates the gestures of the users relative to the holotag projection by taking in information from the primary computing device's sensors and one or more computing device sensors that may expand the field of view and depth available to the application.

Further, the holotag projection content may be altered continuously with the gesture feedback algorithm preferably located on the primary computing device, although theoretically the computing demand may be shared among the computing devices to handle more intensive interactive objects.

Accordingly, the method 500 may include the user operating their computing device as the primary computing device and share the holotag projection content shown and interacted with to one or more extraneous display devices and subsequently one or more other users. The method 500 then further allow the operation and use of one or more computing devices and subsequently sensors to provide a more comprehensive sensor array that can augment an entire room. The method 500 may permit the immediate response to gestures and correlations thereof to the holotag projection content and extraneous display devices to allow multi-user interactions channeled through the primary computing device.

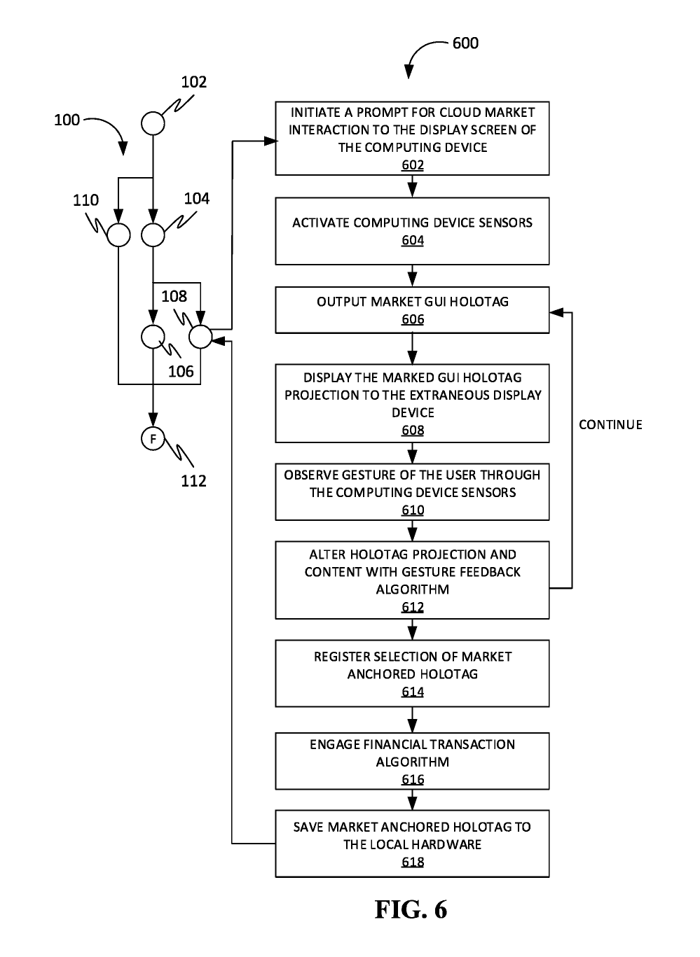

FIG. 6 is a flowchart of a method 600 for initiating the market phase for providing the interactive augmented reality experience in accordance with some embodiments. The method 600 may include a sequence of nine steps in sequence: initiating a prompt for cloud market interaction to the display screen of the computing device at 602, activating computing device sensors at 604, outputting a market GUI holotag at 606, displaying the market GUI holotag projection to the extraneous display device at 608, observing gestures of the user through the computing device sensors at 610, altering holotag projection and content with gesture feedback algorithm at 612, registering selection of market anchored holotag at 614, engaging a financial transaction algorithm at 616, and saving market anchored holotag to the local hardware at 618. Further, the market phase method 600 may loop continuously from altering the holotag projection (at 612) and content with the gesture feedback algorithm to outputting the market GUI holotag (at 606).

The initiation of the market phase may preferably proceed the operation phase. The operation mode's protocol may enable viewing the market available content in holotag projection form, but may alternatively initiate the holotag projection and gesture feedback algorithm at the onset of the market phase. The market phase may connect to the cloud and market network wherein vendor or extraneous user supplied holotags may be exchanged with a financial transaction algorithm that draws on the information provided in the registration phase.

Further, a prompt for cloud market interaction may be initiated and forwarded to the display screen of the computing device, wherein the user may confirm or deny the activation of the cloud market interaction mode through physical inputs on the computing device or through gestures within the operation mode gesture feedback algorithm. If the computing device sensors are not already activated, the application may engage and activate the computing device sensors to allow a preferable gesture driven cloud market interaction.

Further, the market GUI holotag may be subsequently outputted to the computing device display screen. Further, an extraneous registered user may be allowed to peruse the cloud market in tandem with the initial user such as couples or the like when authorized on the computing device. The market GUI holotag projection may be then displayed on the extraneous display devices constituted of a virtualized, digitized market interface that the user may scroll through and select with appropriate gestures. The computing device may then proceed to observe the gestures of the user through the computing device sensors in relation and proximity to the digitized market GUI projection. The computing device may then alter the holotag projection and content of the market GUI holotag with the gesture feedback algorithm by altering the selection, angle of view, or any manipulatable elements and reflecting such changes to the extraneous display device.

Moreover, upon reaching a desired option within the market GUI holotag projection, the computing device may register the selection of a market anchored holotag that may optionally provide immediate interaction or otherwise demonstration authorized content. Further, the computing device may engage a financial transaction algorithm that makes use of the first data set and information therein concerning the user, potentially age, financial institution or payment information, to authorize and transfer the market anchored holotag from the market place to the user and the exchange of payment from the user to the market place and subsequently the vendor's financial institution. The computing device may then save the market anchored holotag to the local hardware and preferably lifts most if not all restrictions on the market anchored holotag to enable to user to freely interact and reasonably manipulate within the programmable phase of the application.

Accordingly, the method 600 may allow the user to engage in a cloud network based plurality of users and vendors to purchase and offer holotag content to their computing device wherein they may view the holotag content to some capacity as though bought.

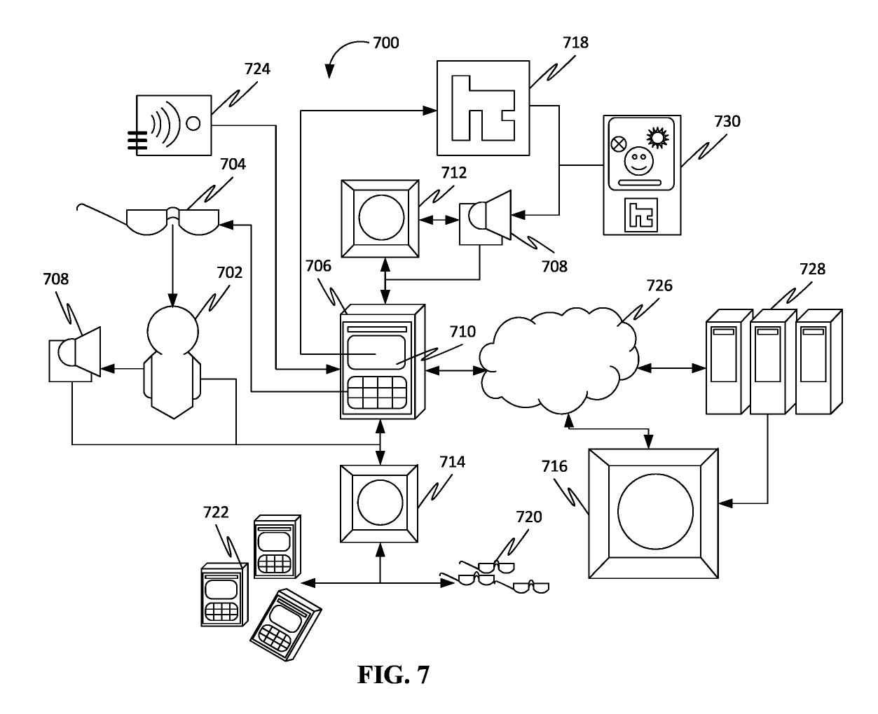

FIG. 7 illustrates a system 700 for providing the interactive augmented reality experience in accordance with some embodiments. A user 702 may wear an extraneous display device 704, interact with a computing device 706, and may engage a sensor 708 through gestures in view of the sensor 708. The computing device 706 may engage the operation, shared operation, and a cloud network 726 while being acted upon by the user 702 and sensors 708, 722. The computing device 706 may further include a computing device display screen 710 that outputs the holotag display. The computing device display screen 710 may be comprised within the computing device 706 and outputs the holotag display. An operation phase program 712 may communicate between the computing device 706 and the sensor 708 while supplying the holotag projection content to the extraneous display device 704.

Further, a shared operation mode program 714 may allow communication between the computing device 706 as the primary computing device, one or more other computing devices, and one or more extraneous display devices to share the output of the primary computing device to all registered extraneous display devices.

Further, a market mode program 716 may communicate between the cloud network 726 and a remote database 728 of information supplied by both communicating devices and vendors. Further, the user may opt into a market mode and conduct business or patronage.

A holotag 718 may be outputted from the computing device display 710 in the local instance. The sensor 708 may detect local holotags located on the computing device 706, extraneous holotags 730 located on other computing devices or extraneous media such as posters, and additionally receives input from the user through gestures made in proximity to the holotag projection.

The extraneous display device 704 may be a pair of screen equipped glasses or other headgear and is worn by the user. The headgear may be connected to a proximity sensor for orientation to the computing device and holotag projection content. The extraneous display device 704 may further supply a stream of images and data from the computing device 706.

Further, an instance of one or more extraneous display devices 720 may share holotag projection content with the primary computing device 706 during a shared operation mode.

Further, an instance of one or more computing devices 722 that may be utilized to modularly expand the sensor capacity and enable a larger environment to utilize gestures during the shared operation mode.

Further, a proximity sensor 722 may be equipped to the extraneous display device 704 and may define the location and orientation of the extraneous display device 704 in relation to the computing device 706 and holotag projection content.

Further, the cloud network 724 may be augmented by the application wherein the market mode may engage, utilize and additionally communicate with the remote database 728.

Further, the remote database 728 may store the information of the computing device's user and registration information, as well as offering augmented conventional services that are optimized for the application to use such as email, chat, videos, and so on.

Further, the extraneous holotag 730 may be embedded onto external media, structures, or running entertainment wherein the sensor of the computing device 706 may observe, interact, and even capture to store into the local hardware of the computing device 706.

According to embodiments, the present disclosure provides augmented reality experience through a registration, operation, programmable, shared operation, and market phase protocol that enables the user to additionally synchronize one or more extraneous computing devices and one or more extraneous display devices. Further, the user may be able to turn on the computing device, put on their extraneous display device such as a screen equipped pair of glasses and synchronize to the computing device. Thereafter, the user may observe a startup hologram or holotag projection content, and the user may operate a digitized and virtual computing device. Thereafter, the user may go through messages, engage a virtual keyboard to produce an email, or even open up a video streaming service to watch the video content on the virtual computing device. Further, the disclosure relates to devices that also produce interactive objects from external producers or produced natively in the programmable mode wherein content may be captured in the operation or market phase of the protocol. By engaging in the shared operation mode, multiple extraneous computing devices may interact with the primary computing device that expands the view and field of the sensors through a handshaking protocol that syncs the extraneous computing devices. The same protocol may additionally broadcast multiple discretized streams of information to an equal count of extraneous display devices that uniquely reflect orientation and proximity to the holotag projection content. Thus, the present disclosure may offer a universalized augmented reality experience that may agilely engage multiple computing devices and sensors, multiple extraneous display devices, and offer a highly mutable platform to engage a multitude of augmented reality and holotag projection content.

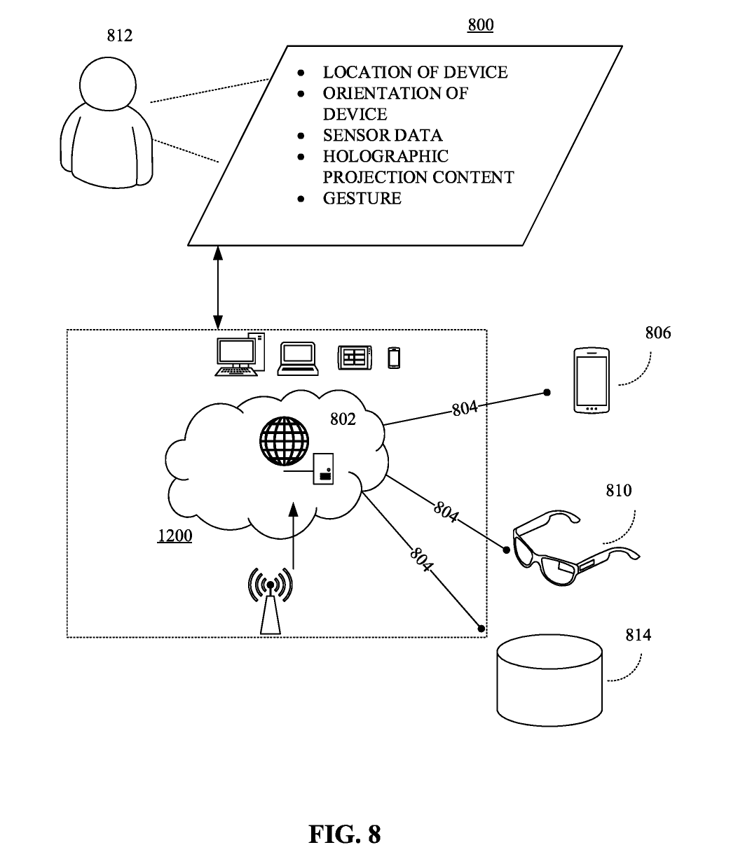

FIG. 8 is an illustration of a platform 800 consistent with various embodiments of the present disclosure. By way of non-limiting example, the online platform 800 for facilitating provisioning of holographic content may be hosted on a centralized server 802, such as, for example, a cloud computing service. The centralized server 802 may communicate with other network entities, such as, for example mobile devices 806 (such as a smartphone, a laptop, a tablet computer etc.), wearable devices 810 (such as smart glasses, etc.), databases 814 (such as holographic content databases), via a communication network 804 such as, but not limited to, the Internet. Further, users of the platform may include one or more relevant parties such as users, content providers, companies and system administrators. Accordingly, electronic devices operated by the one or more relevant parties may be in communication with the platform 800.

A user 812, such as the one or more relevant parties, may access the platform 800 through a software application. The software application may be embodied as, for example, but not be limited to, a website, a web application, a desktop application, and a mobile application compatible with a computing device 1200.

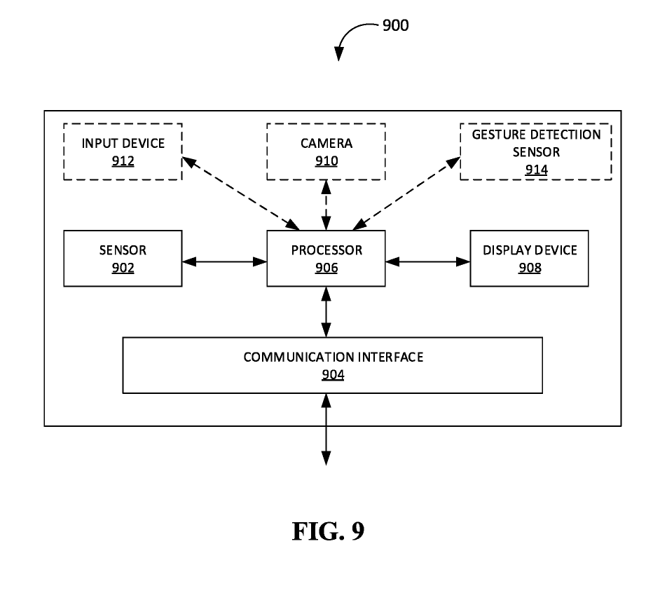

FIG. 9 is a block diagram of a wearable display device 900 configured to facilitate provisioning of holographic content in cooperation with one or more computing devices in accordance with some embodiments. The holographic content may include a virtual three-dimensional image of an object. Further, the wearable display device 900 may be smart glasses, such as Microsoft HoloLens™ and Google Glass™. The wearable display device 900 may include one or more sensors 902 configured to detect sensor data corresponding to one or more of a location and an orientation of the wearable display device 900.

Further, the wearable display device 900 may include a communication interface 904 configured to transmit the sensor data to the one or more computing devices. The communication interface 904 may be configured to receive holographic projection content from the one or more computing devices. The communication interface may include one or more of a wired communication interface and a wireless communication interface. For example, the communication interface may be based on a near-field communication protocol such as, but not limited to, Bluetooth, ZigBee, Infrared (IR) communication, RFID and so on. Alternatively, and/or additionally, the wireless communication interface may be based on a wireless network such as, but not limited to, WiFi, WiMax, Wibro, WiGig, WLAN etc. Further, the holographic projection content may be generated by the one or more computing devices based on the sensor data.

Further, the wearable display device 900 may include a processor 906 communicatively coupled to the communication interface 904. Further, the processor 906 may be configured to process the holographic projection content.

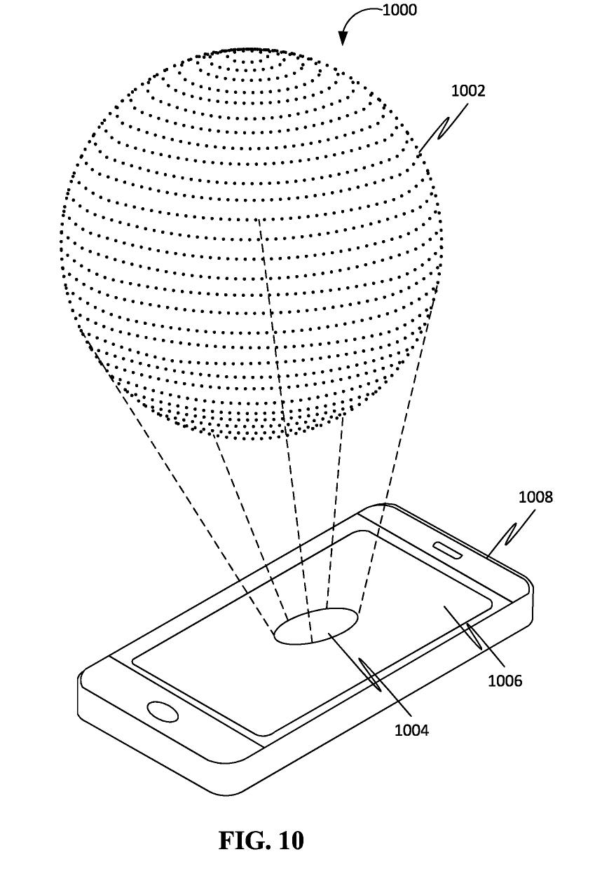

Further, the wearable display device 900 may include a display device 908 communicatively coupled to the processor 906. Further, the display device 908 may be configured to generate a visual display of the holographic projection content. As shown in FIG. 10, the display device 908 may generate a visual display of the holographic projection content comprising a virtual ball 1002.

In some embodiments, the wearable display device 900 may further include one or more optical markers configured to facilitate determination of one or more of the location and the orientation. For example, the optical marker may be one of a linear barcode and a matrix (2D) barcode (such as a QR code). Further, the one or more computing devices may be configured to perform the determination based on at least one image of the one or more optical markers.

In some embodiments, the wearable display device 900 may further include a camera 910 communicatively coupled to the processor 906. For example, the camera 910 may include an electronic image sensor, such as a charge-coupled device (CCD) or a CMOS sensor to capture images. Further, the camera 910 may be configured to capture one or more holotags. Accordingly, the one or more holotags may include optically encoded information. For example, the one or more holotags may include a barcode, a QR code and so on. Further, the processor 906 may be configured to analyze the one or more holotags. Further, the communication interface 904 may be configured to establish a communication session with the one or more computing devices based on the analysis of the one or more holotags. Further, the communication session may include one or more of transmission of the sensor data and reception of the holographic projection content.

In some embodiments, the one or more holotags may be rendered on one or more displays of the one or more computing devices. For example, as shown in FIG. 10, a holotag 1004 may be rendered on a display 1006 of a mobile device 1008. Further, the holographic projection content may be anchored to the one or more holotags. As shown in FIG. 10, the ball-shaped holographic projection content 1002 may be anchored to the holotag 1004.

In some embodiments, the one or more holotags may be imprinted on a physical object. For example, the physical object may be an artifact in a museum. Accordingly, the communication interface 904 may be further configured to transmit the one or more holotags to the one or more computing devices.

In some embodiments, the wearable display device 900 may further include an input device 912 configured to receive authentication data. For example, the input device 912 may include at least one biometric sensor configured to detect a biometric variable associated with one or more users. For example, the at least one biometric sensor may be related to one or more of fingerprint recognition, face recognition, iris recognition, voice recognition. Accordingly, the authentication data may also include the biometric variable. Further, the communication interface 904 may be configured to transmit the authentication data to the one or more computing devices. Further, the one or more computing devices may be configured to authenticate the wearable display device 900 based on the authentication data. Further, reception of the holographic projection content may be based on authentication of the wearable display device 900.

In some embodiments, the wearable display device 900 may further include one or more gesture detection sensors 914 communicatively coupled to the processor 906. For example, the one or more gesture detection sensors 914 may include a hand gesture recognition sensor that utilizes ultra-wideband impulse signals, which are reflected from a hand of a user. Further, the one or more gesture detection sensor 914 may be configured to detect gesture sensor data. Further, the processor 906 may be configured to detect one or more gestures performed by one or more users based on the gesture sensor data. Further, the communication interface 904 may be configured to transmit indication of the one or more gestures to the one or more computing devices. Yet further, the communication interface 904 may be configured to receive an updated holographic projection content from the one or more computing devices. The updated holographic projection content may be generated by the one or more computing devices based on the indication of the one or more gestures.

For example, the one or more gestures may include a user using his hand to flick the ball-shaped holographic projection content 1002. Accordingly, the updated holographic projection content received from the one or more computing devices may include the ball-shaped holographic projection content 1002 rotated by a certain degree in the direction of the flick gesture.

In further embodiments, the processor 906 may be configured to determine a spatial correlation between the one or more gestures and the holographic projection content. The processor 906 may be further configured to detect the one or more gestures further based on the spatial correlation.

In some embodiments, the communication interface 904 may be further configured to receive an updated holographic projection content from the one or more computing devices. Further, the updated holographic projection content may be generated by the one or more computing devices based on one or more gestures performed by one or more users. Further, the one or more computing devices may include one or more gesture detection sensors configured to detect the one or more gestures. Further, the one or more computing devices may be further configured to generate the updated holographic projection content based on the one or more gestures.

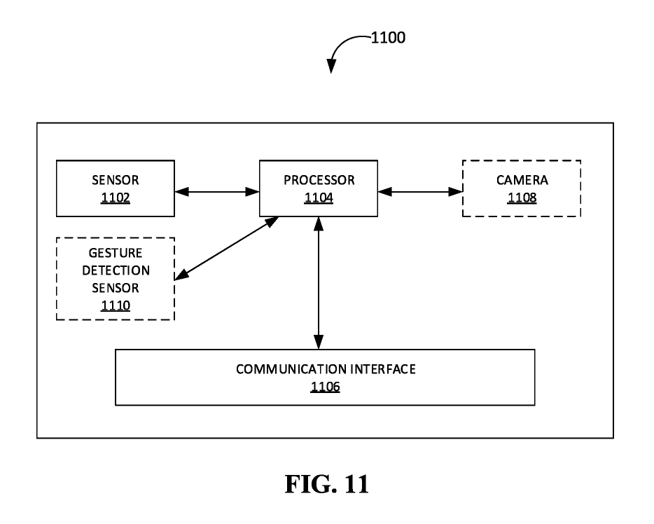

FIG. 11 is a block diagram of a computing device 1100 configured to facilitate provisioning of holographic content in cooperation with one or more wearable display devices (such as wearable devices 810) in accordance with some embodiments. The computing device 1100 may include one or more sensors 1102 configured to detect sensor data corresponding to one or more of a location and an orientation of the one or more wearable display devices.

Further, the computing device 1100 may include a processor 1104 communicatively coupled to the one or more sensors 1102. Further, the processor 1104 may be configured to generate at least one holographic projection content based on the sensor data.

Further, the computing device 1100 may include a communication interface 1106 configured to transmit the at least one holographic projection content to the one or more wearable display devices. Further, the one or more wearable display devices may be configured to generate at least one visual display of the holographic projection content.

In some embodiments, the one or more wearable display devices may include a plurality of wearable display devices. Further, the sensor data may include one or more of a plurality of locations and a plurality of orientations corresponding to the plurality of wearable display devices. Further, the at least one holographic projection content may include a plurality of holographic projection content corresponding to one or more of the plurality of locations and a plurality of orientations.

In some embodiments, the one or more sensors 1102 may include a camera 1108 configured to capture at least one image of at least one optical marker disposed on the one or more wearable display devices. Further, the processor 1104 may be configured to analyze the at least one image. Yet further, the processor 1104 may be configured to determine one or more of the location and the orientation of the one or more wearable devices based on analysis of the at least one image.

In some embodiments, the camera 1108 may be configured to capture one or more holotags. Further, the processor 1104 may be configured to analyze the one or more holotags. Further, the communication interface 1106 may be configured to establish a communication session with the one or more wearable display devices based on the analysis of the one or more holotags. Further, the communication session may include transmission of the at least one holographic projection content to the one or more wearable display devices.

In some embodiments, the computing device 1100 may further include at least one gesture detection sensor 1110 communicatively coupled to the processor 1104. Further, the at least one gesture detection sensor 1110 may be configured to detect gesture sensor data. Further, the processor 1104 may be configured to detect one or more gestures performed by one or more users associated with the one or more wearable display devices based on the gesture sensor data. Further, the processor 1104 may be further configured to generate an updated holographic projection content based on the gesture sensor data. Further, the communication interface 1106 may be further configured to transmit the updated holographic projection content to the one or more wearable display devices.

In some embodiments, the processor 1104 may be further configured to determine at least one spatial correlation between the at least one gesture and the at least one holographic projection content. Further, the processor 1104 may be configured to detect the at least one gesture further based on the at least one spatial correlation.

According to some embodiments, a method for providing holographic content based on the cooperation of at least one computing device and at least one extraneous display device is disclosed. The at least one extraneous display device may include a screen equipped pair of glasses. Further, the at least one computing device may include at least one of a laptop computer, a smartphone, a desktop computer and a wearable computer.

Further, the at least one computing device may be configured to receive identifying information associated with at least one user. Yet further the at least one computing device is further configured for uploading the identifying information to a cloud storage.

Further, the method may include establishing, using a communication interface, a communication session between the at least one computing device and the at least one extraneous display device. In some embodiments, the at least one computing device may be configured to synchronize with the at least one extraneous display device. Further, in some embodiments, the at least one computing device is configured to synchronize with a plurality of extraneous display devices. The method may further include registering each of the plurality of extraneous display devices with the at least one computing device.

Further, the method may include determining, using at least one sensor, sensor data corresponding to one or more of a location and an orientation associated with the at least one extraneous display device.

Further, the method may include generating, using a processor, holographic projection content based on the sensor data. Further, the method may include transmitting, using the communication interface, the holographic projection content from the at least one computing device to the at least one extraneous display device. Further, the at least one extraneous display device may be configured for displaying the holographic projection content.

In some embodiments, the at least one extraneous display device may include a proximity sensor and an orientation sensor, wherein the proximity sensor is configured to determine a distance of the at least one extraneous display device to the computing device, wherein the orientation sensor is configured to determine an orientation of the at least one extraneous display device in relation to the computing device.

In some embodiments, the method may further include receiving at least one registration data associated with at least one extraneous display device. Further, the establishing of the communication session may be based on the at least one registration data.

In some embodiments, the method may further include determining, using a gesture detection sensor, at least one gesture associated with the at least one user; generating, using the processor, an updated holographic projection content; transmitting, using the communication interface, the updated holographic projection content from the at least one computing device to the at least one extraneous display device.

In some embodiments, the method may further include determining, using the processor, at least one correlation between the at least one gesture and the holographic projection content. Further, the generating of the updated holographic projection content may be based on the at least one correlation.

In some embodiments, the at least one computing device comprises a display screen configured to generate a holographic projection. Further, the at least one computing device may be configured to generate the holographic projection, wherein the at least one computing device may be further configured to transmit the holographic projection content to the at least one extraneous display device.

In further embodiments, the at least one computing device may include a gesture detection device configured to detect a gesture performed by at least one user. Further, the at least one computing device is configured to determine a correlation between the gesture and the holographic projection content generated by the at least one computing device, wherein the at least one computing device is further configured to generate an updated holographic projection content based on a holographic projection content and the gesture. Moreover, the method may include storing, using a storage device, the updated holographic projection content.

Further, the holographic projection may include a projection of a virtual representation of the at least one computing device, wherein the virtual representation is configured to provide optimum user interaction.

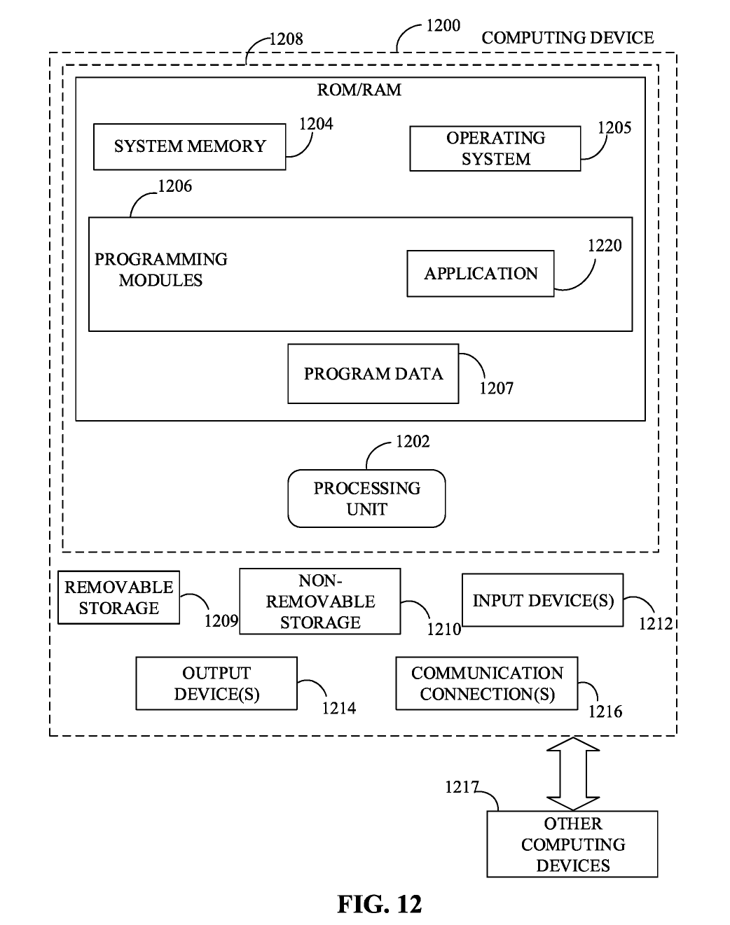

FIG. 12 is a block diagram of a system including computing device 1200. Consistent with an embodiment of the disclosure, the aforementioned memory storage and processing unit may be implemented in a computing device, such as computing device 1200 of FIG. 12. Any suitable combination of hardware, software, or firmware may be used to implement the memory storage and processing unit. For example, the memory storage and processing unit may be implemented with computing device 1200 or any of other computing devices 1218, in combination with computing device 1200. The aforementioned system, device, and processors are examples and other systems, devices, and processors may comprise the aforementioned memory storage and processing unit, consistent with embodiments of the disclosure.

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. Accordingly, in some embodiments, the programming modules 1206 may be implemented using one or more of software and hardware. For example, in an instance, the programming modules 1206 may be implemented as modules of a Digital Signal Processor (DSP). Further, in another instance, multiple types of completely DSP chip powered and/or analog physical hardware unit designs may be used. Further, the implementation of the programming modules could also be a combination of mostly DSP modules with some analog modules/processing as well. Further, in some embodiments, as long as the dithering module is implemented via a DSP chip, technically the rest of the modules may be analog modules. Accordingly, stress testing may be performed to determine which components would be best for each unit's physical size limitations.

Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and nonvolatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220) may perform processes including, for example, one or more stages of methods, algorithms, systems, applications, servers, databases as described above. The aforementioned process is an example, and processing unit 1202 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A wearable display device configured to facilitate provisioning of holographic content in cooperation with at least one computing device, the wearable display device comprising:
at least one sensor configured to detect sensor data corresponding to at least one of a location and an orientation of the wearable display device;
a communication interface configured to:
transmit the sensor data to the at least one computing device; and
receive holographic projection content from the at least one computing device, wherein the holographic projection content is generated by the at least one computing device based on the sensor data;
a processor communicatively coupled to the communication interface, wherein the processor is configured to process the holographic projection content; and
a display device communicatively coupled to the processor, wherein the display device is configured to generate a visual display of the holographic projection content.

2. The wearable display device of claim 1 further comprising at least one optical marker configured to facilitate determination of at least one of the location and the orientation, wherein the at least one computing device is configured to perform the determination based on at least one image of the at least one optical marker.

3. The wearable display device of claim 1 further comprising a camera communicatively coupled to the processor, wherein the camera is configured to capture at least one holotag, wherein the processor is configured to analyze the at least one holotag, wherein the communication interface is configured to establish a communication session with the at least one computing device based on the analysis of the at least one holotag, wherein the communication session comprises at least one of transmission of the sensor data and reception of the holographic projection content.

4. The wearable display device of claim 1 further comprising an input device configured to receive authentication data, wherein the communication interface is further configured to transmit the authentication data to the at least one computing device, wherein the at least one computing device is configured to authenticate the wearable display device based on the authentication data, wherein reception of the holographic projection content is based on authentication of the wearable display device.

5. The wearable display device of claim 4, wherein the input device comprises at least one biometric sensor configured to detect a biometric variable associated with at least one user, wherein the authentication data comprises the biometric variable.

6. The wearable display device of claim 3, wherein the at least one holotag is rendered on at least one display of the at least one computing device, wherein the holographic projection content is anchored to the at least one holotag.

7. The wearable display device of claim 3, wherein the at least one holotag is imprinted on a physical object, wherein the communication interface is further configured to transmit the at least one holotag to the at least one computing device.

8. The wearable display device of claim 1 further comprising at least one gesture detection sensor communicatively coupled to the processor, wherein the at least one gesture detection sensor is configured to detect gesture sensor data, wherein the processor is configured to detect least one gesture performed by at least one user based on the gesture sensor data, wherein the communication interface is further configured to:
transmit indication of the at least one gesture to the at least one computing device; and
receive an updated holographic projection content from the at least one computing device, wherein the updated holographic projection content is generated by the at least one computing device based on the indication of the at least one gesture.

9. The wearable display device of claim 8, wherein the processor is configured to determine a spatial correlation between the at least one gesture and the holographic projection content, wherein the processor is further configured to detect the at least one gesture further based on the spatial correlation.

10. The wearable display device of claim 1, wherein the communication interface is further configured to receive an updated holographic projection content from the at least one computing device, wherein the updated holographic projection content is generated by the at least one computing device based on at least one gesture performed by at least one user, wherein the at least one computing device comprises at least one gesture detection sensor configured to detect the at least one gesture, wherein the at least computing device is further configured to generate the updated holographic projection content based on the at least one gesture.

11. A computing device configured to facilitate provisioning of holographic content in cooperation with at least one wearable display device, the computing device comprising:
at least one sensor configured to detect sensor data corresponding to at least one of a location and an orientation of the at least one wearable display device;
a processor communicatively coupled to the at least one sensor, wherein the processor is configured to generate at least one holographic projection content based on the sensor data; and
a communication interface configured to transmit the at least one holographic projection content to the at least one wearable display device, wherein the at least one wearable display device is configured to generate at least one visual display of the holographic projection content.

12. The computing device of claim 11, wherein the at least one wearable display device comprises a plurality of wearable display devices, wherein the sensor data comprises at least one of a plurality of locations and a plurality of orientations corresponding to the plurality of wearable display devices, wherein the at least one holographic projection content comprises a plurality of holographic projection content corresponding to at least one of the plurality of locations and a plurality of orientations.

13. The computing device of claim 11, wherein the at least one sensor comprises a camera configured to capture at least one image of at least one optical marker disposed on the at least one wearable display device, wherein the processor is configured to:
analyze the at least one image; and
determine at least one of the location and the orientation of the at least one wearable display device based on analysis of the at least one image.

14. The computing device of claim 11 further comprising a camera communicatively coupled to the processor, wherein the camera is configured to capture at least one holotag, wherein the processor is configured to analyze the at least one holotag, wherein the communication interface is configured to establish a communication session with the at least one wearable display device based on the analysis of the at least one holotag, wherein the communication session comprises transmission of the at least one holographic projection content to the at least one wearable display device.

15. The computing device of claim 11 further comprising at least one gesture detection sensor communicatively coupled to the processor, wherein the at least one gesture detection sensor is configured to detect gesture sensor data, wherein the processor is configured to detect least one gesture performed by at least one user associated with the at least one wearable display device based on the gesture sensor data, wherein the processor is further configured to generate an updated holographic projection content based on the gesture sensor data, wherein the communication interface is further configured to transmit the updated holographic projection content to the at least one wearable display device.

16. The computing device of claim 15, wherein the processor is further configured to determine at least one spatial correlation between the at least one gesture and the at least one holographic projection content, wherein the processor is further configured to detect the at least one gesture further based on the at least one spatial correlation.

17. A method for providing holographic content based on cooperation of at least one computing device and at least one extraneous display device, the method comprising:
establishing, using a communication interface, a communication session between the at least one computing device and the at least one extraneous display device;
determining, using at least one sensor, sensor data corresponding to at least one of a location and an orientation associated with the at least one extraneous display device;
generating, using a processor, holographic projection content based on the sensor data;
transmitting, using the communication interface, the holographic projection content from the at least one computing device to the at least one extraneous display device, wherein the at least one extraneous display device is configured for displaying the holographic projection content.

18. The method of claim 17 further comprising receiving at least one registration data associated with at least one extraneous display device, wherein the establishing of the communication session is based on the at least one registration data.

19. The method of claim 18 further comprising:
determining, using a gesture detection sensor, at least one gesture associated with the at least one user;
generating, using the processor, an updated holographic projection content;
transmitting, using the communication interface, the updated holographic projection content from the at least one computing device to the at least one extraneous display device.

20. The method of claim 19 further comprising determining, using the processor, at least one correlation between the at least one gesture and the holographic projection content, wherein the generating of the updated holographic projection is based on the at least one correlation.
